(19) United States
(12) Patent Application Publication
(10) Pub. No.: US 2013/0113151 A1
(43) Pub. Date: May 9, 2013

(54) Crushing Bags and Methods for Use and Manufacture

(71) Applicant: Douglas Dufaux, Orchard Park, NY (US)

(72) Inventor: Douglas Dufaux, Orchard Park, NY (US)

(21) Appl. No.: 13/698,205

(22) PCT Filed: Oct. 11, 2010
(86) PCT No.: PCT/US2010/052153

§ 371 Date: Jan. 22, 2013

Related U.S. Application Data
(60) Provisional application No. 61/251,084, filed on Oct. 13, 2009.

(51) Int. Cl. B02C 19/00

(52) U.S. Cl. CPC B02C 19/0056
USPC 269/287

(57) ABSTRACT

A pill crusher pouch is constructed of a flexible sheet material having an open top and an open bottom, wherein the open bottom is dimensionally smaller than the open top, forming a funnel-like internal pouch cavity, and a crease near the bottom of the pouch that allows a user to easily fold the pouch to form a temporary seal that prevents crushed pill product from dispensing through the open bottom until the user unfolds the pouch.

PRIORITY CLAIM

This application claims priority to U.S. Provisional Patent Application No. 61/251,084, filed Oct. 13, 2009.

### FIELD OF THE INVENTION

The present invention relates generally to patient care devices and, more particularly, to pouches for pill crushing devices.

### BACKGROUND

Many medications are produced in a pill or tablet form (hereinafter generically referred to as a pill) for a variety of reasons, including an improved shelf-life and stability in this dry form. Pills come in a variety of sizes and shapes and often are hard compacts of dry powders.

Although convenient for storage and manufacture, a hard pill cannot always be consumed by a patient. This is particularly true in some institutional environments, such as nursing homes, where elderly patients may have a hard time swallowing. In these and other cases, it is recommended by doctors and pharmacists to crush the pill rather than trying to having the patient consume it whole. The product of crushing is a dry powder that can easily be combined with a carrier such as applesauce, fruit juice, or other consumable more palatable to the patient. As such, various pill-crushing devises are known in the art.

Many pill-crushing devices exist, including pill-crushing device described in U.S. Pat. No. 5,915,637, U.S. Pat. No. 7,347,394, and U.S. Pat. No. 7,051,963 and provide a convenient mechanical action to help provide the force to crush a pill. Pill crushing pouches exist as well, such as those described in the '637, '394, and '963 patents.

A need still remains for a convenient pouch, that is easy and quick to use, cheap to manufacture, and provides for a vehicle that assures that the patient receives the full dosage of a prescribed medication.

### SUMMARY

A pill crusher pouch is disclosed that comprises a flexible sheet material that is folded flat upon itself to provide a close interior with sufficiently tight wall to wall contact to help facilitate pill crushing there between, with the interior walls being sealed along longitudinal edges to form a pouch having a front panel and a back panel. The pouch is open on the top and bottom portions which allow the easy releasing of any accumulation of pulverized pill material therein to facilitate the dispensing of pulverized pill material from the dose interior of said open pouch. In one embodiment, the pill crusher pouch is made of transparent material. In a further embodiment, the pill crusher pouch is composed primarily of polyethylene.

### BRIEF DESCRIPTION OF THE DRAWINGS

The following detailed description of embodiments of the present invention can be best understood when read in conjunction with the following drawings, where like structure is indicated with like reference numerals and in which:

FIG. 1A is a front perspective view of a pill crusher pouch which is constructed in accordance with the present invention;

FIG. 1B is a front perspective view of the pill crusher pouch of FIG. 1A;

FIG. 2A is a front view of the pill crusher pouch of FIGS. 1;

FIG. 2B is a front view of the pill crusher pouch of FIG. 1;

FIG. 3A is a front view of another pill crusher pouch which is constructed in accordance with the present invention;

FIG. 3B is a front view of the pill crusher pouch of FIG. 3A;

FIG. 4A is a front view of another pill crusher pouch which is constructed in accordance with the present invention;

FIG. 4B is a front view of the pill crusher pouch of FIG. 4A;

FIG. 4C is a front view of the pill crusher pouch of FIG. 4A and FIG. 4B, after a perforated dispensing section has been deployed;

FIG. 4D is a front view of another pill crusher pouch which is constructed in accordance with the present invention;

FIG. 5A is a front view of another pill crusher pouch which is constructed in accordance with the present invention;

FIG. 5B is a front view of the pill crusher pouch of FIG. 5A;

FIG. 6A is a front view of another pill crusher pouch which is constructed in accordance with the present invention;

FIG. 6B is a front view of the pill crusher pouch of FIG. 6A;

FIG. 7A is a front view of another pill crusher pouch which is constructed in accordance with the present invention;

FIG. 7B is a front view of the pill crusher pouch of FIG. 6A;

FIG. 7C is a front view of the pill crusher pouch of FIG. 6A and 6B;

FIG. 7D is a front view of the pill crusher pouch of FIG. 6A, 6B, and 6C;

FIG. 8A is a front view of another pill crusher pouch which is constructed in accordance with the present invention;

FIG. 8B is a front view of the pill crusher pouch of FIG. 8A;

FIG. 9 is a front view of another pill crusher pouch which is constructed in accordance with the present invention;

### DETAILED DESCRIPTION OF EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers expressing quantities of ingredients, properties such as weight fraction, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in specific examples are reported as precisely as possible. Any numerical values, however, inherently contain certain errors necessarily resulting from error found in their respective measurements.

Bags or pouches for pill crushing and dispensing are disclosed. The bags may be dimensioned to be received between a platen-and-anvil type of a pill crusher as described in U.S. Pat. No. 7,051,963 to Buckley (“the '963 patent”), which is incorporated in its entirety herein by reference, or may be of any convenient size to be used with other types of crushing devices. The pouches of the invention described herein provide for a method of dispensing the crushed pill product as compared to the prior art that is both more convenient for the operator and minimizes the amount of residual crushed product that remains trapped in the pouch after dispensing.

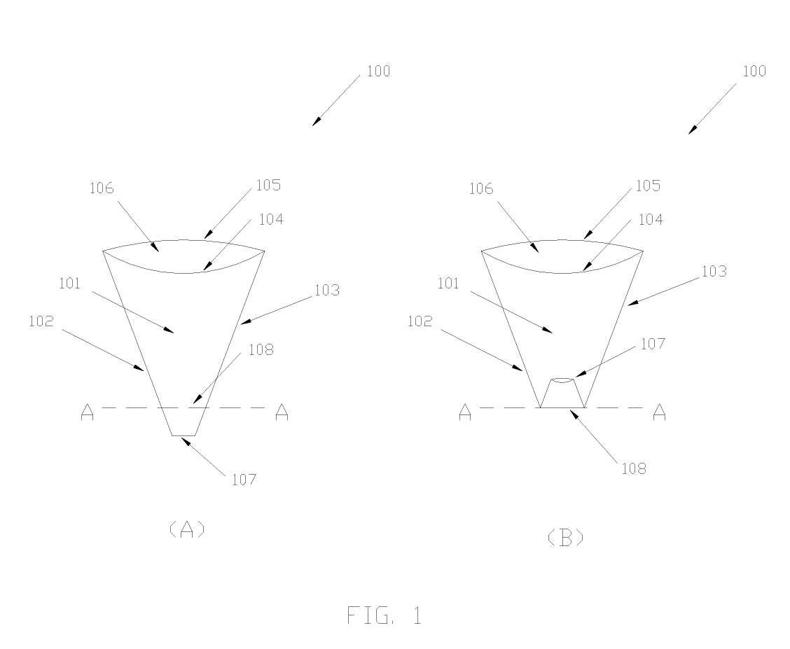

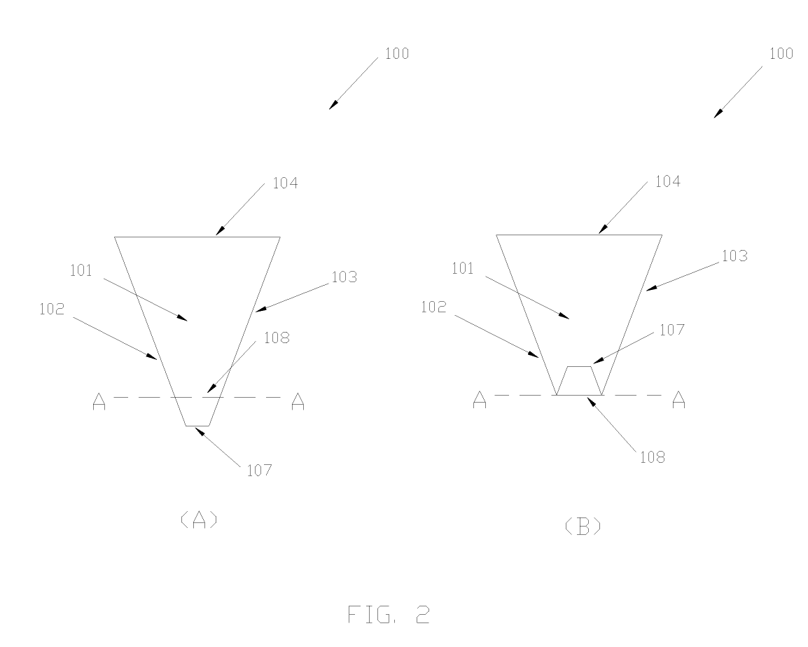

Referring now to the figures, FIG. 1(a) shows a view of a pill crushing pouch according to the present invention. The pouch 100 includes a front face 101, a left edge 102, a right edge 103, a top front edge 104, a top rear edge 105, an internal cavity 106, a dispensing end 107, and a fold line 108. FIG. 1(b) shows the pouch 100 of FIG. 1(a), where the pouch 100 has been folded at fold line 108. FIG. 2(a) shows a front view of the pouch 100, and FIG. 2(b) shows a front view of the pouch 100 where the pouch 100 has been folded at fold line 108. Note that line A-A denotes the fold line in FIG. 1, FIG. 2, and subsequent figures.

In operation, the pouch 100 is prepared for use by folding at fold line 108 such that the pouch 100 looks generally similar to FIGS. 1(b) and 2(b). The fold serves to create a temporary seal or partition near the bottom of the pouch 100 that prevents the pulverized pill product from falling out of the pouch 100 until the operator is ready to dispense the product. The fold may be secured by the operator while the pill is being crushed, by for example, holding the pouch 100 with a thumb and forefinger at a point slightly above the fold line thus pinching the folded portion of the pouch together. Optionally, the operator may use an alternative means to secure the fold such as a paperclip or a piece of tape, or other convenient means. The operator may crush the pill horizontally or nearly horizontally, which may eliminate the need to hold the fold, depending in part on the type of material used to manufacture the pouch 100.

At this point, one or more pills are placed in the pouch 100, such that the pill or pills resides inside of the pouch 100, in the internal cavity 106. The pouch 100 containing the pill or pills can then be inserted fully or partially into a pill crushing device, such as the device described in the '963 patent or the pills can be crushed through any available means, including crushing with a hammer or other blunt device. After the desired amount of crushing has been achieved, the operator can remove the pouch 100 from the crushing device, with the fold still intact, and the product is now ready for dispensing. Once the operator is ready to dispense the product into a receiving container, such as a cup of applesauce, the operator simply positions the pouch 100 over the receiving container, and removes the fold such that the pouch 100 looks similar to that shown in FIG. 1(a) and FIG. 2(a). The pouch 100 appears in this form similar to a funnel, and the crushed pill product easily slides down the and exits the pouch 100 at the dispensing end 107. Optionally, while still positioned over the receiving container, the pouch 100 may be tapped gently with a finger or pencil or other convenient device to free any residual pill product that may be adhered to the walls of the pouch 100. Alternatively, the pouch 100 may again be folded at the fold line 108, remain in position over the receiving container or moved to a more convenient location and tapped or vibrated to free any residual crushed product. At this point, the pouch 100 is again positioned over the receiving container and unfolded to dispense the residual product. This process may be optionally repeated if desired.

Optionally, the fold line 108 may be enhanced during manufacturing, by pressing, applying heat, or by other means, such that it is readily apparent by a user where to fold, and such that it is easy to fold at the fold line 108. It may be optionally marked with a line to indicate to a user where the pouch 100 should be folded.

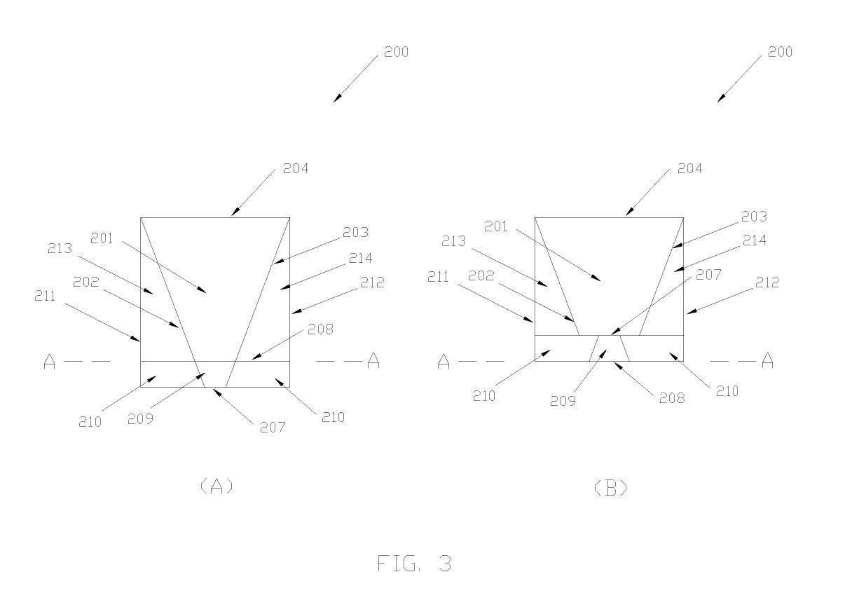

Referring now to FIG. 3, FIGS. 3(a) and 3(b) show another pill crushing pouch according to the present invention. The pouch 200 includes a front face 201, a left edge 202, a right edge 203, a top front edge 204, an internal cavity 206, a dispensing end 207, a fold line 208, a lower fold section 209, lower void cavities 210, a left outer edge 211, a right outer edge 212, a left void cavity 213, and a right void cavity 214. FIG. 3(b) shows the pouch 200 of FIG. 3(a), where the pouch 200 has been folded at fold line 208.

The pouch 200 is similar to the pouch 100 described above, except that non-critical portions of the pouch 200 remain, as opposed to being trimmed and discarded or recycled in the pouch 100 of FIGS. 1 and 2. Specifically, the non-critical portions of the pouch 200 are the lower void cavities 210, the left void cavity 213 and the right void cavity 214 (and also the left outer edge 211 and the right outer edge 212). Depending on the cost to trim the non-critical portions during the manufacturing process compared to the value of material as a recycling good, as well as any possible product benefits to the user of one design over the other, a design type will be chosen by a manufacturer. One possible benefit to a user of pouch 200 compared to pouch 100 is that the left outer edge 211 and the right outer edge 212 may provide for a more convenient means for the user to hold the pouch 200 and possible squeeze to open the internal cavity 206 during use.

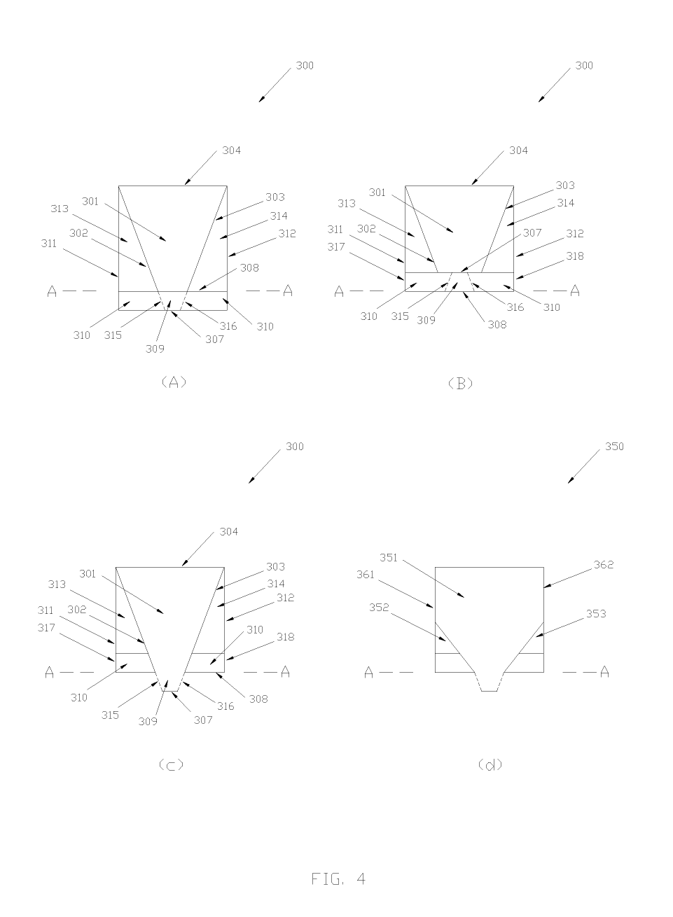

Another advantage of the type of design of pouch 200 is shown in FIG. 4. FIG. 4(a) shows a pouch 300 that includes a front face 301, a left edge 302, a right edge 303, a top front edge 305, a top rear edge 305, an internal cavity 306, a dispensing end 307, a fold line 308, a lower fold section 309, lower void cavities 310, a left outer edge 311, a right outer edge 312, a left void cavity 313, and a right void cavity 314. To illustrate the benefits of the pouch 300, a left folded edge 315 and a right folded edge 316 are designated. The left folded edge 315 and right folded edge 316 are perforated at the factory such that they will easily tear away from the lower void cavities 310 when pulled by a user. It should be noted that the seal forming the internal cavity 306 will remain; the perforations are formed on the outside of such seal.

FIG. 4(b) shows the pouch 300 of FIG. 4(a), where the pouch 300 has been folded at fold line 308. During the manufacturing process, the pouch 300 is folded at the fold line and the left outer edge 311 and right outer edge 312 are sealed causing the material to bond or fuse, creating a left lower sealed outer edge 317 and right lower sealed outer edge 318. At this point, the pouch 300 is ready for use. In use, one or more pills are placed in the pouch 300, such that the pill or pills resides inside of the pouch 300, in the internal cavity 306. The pouch 300 containing the pill or pills can then be inserted fully or partially into a pill crushing device, such as the device described in the '963 patent, or the pills can be crushed through any available means, including crushing with a hammer or other blunt device. After the desired amount of crushing has been achieved, the operator can remove the pouch 300 from the crushing device, and the product is now ready for dispensing. Once the operator is ready to dispense the product into a receiving container, such as a cup of applesauce, the operator simply positions the pouch 300 over the receiving container, and tears the lower fold section 309 away from the lower void cavities 310 at the location of the perforations, the left folded edge 315 and the right folded edge 316. The lower fold section 309 now hangs down and allows the crushed product to easily dispense through the dispensing end 307, as shown in FIG. 4(c).

FIG. 4(d) shows an alleviative to the design shown in FIG. 4 (a) through (c), where the left edge 352, a right edge 353, meet the left outer edge 311 and the right outer edge 312, respectively, at some point below the top edge of the pouch 350. This design may provide the user with a pouch 350 that is easier to open when compared to pouch 300.

As described above, optionally, while still positioned over the receiving container, the pouch 300 may be tapped gently with a finger or pencil or other convenient device to free any residual pill product that may be adhered to the walls of the pouch 300. Alternatively, the lower fold section 309 may again be folded at the fold line 308, remain in position over the receiving container or moved to a more convenient location and tapped or vibrated to free any residual crushed product.

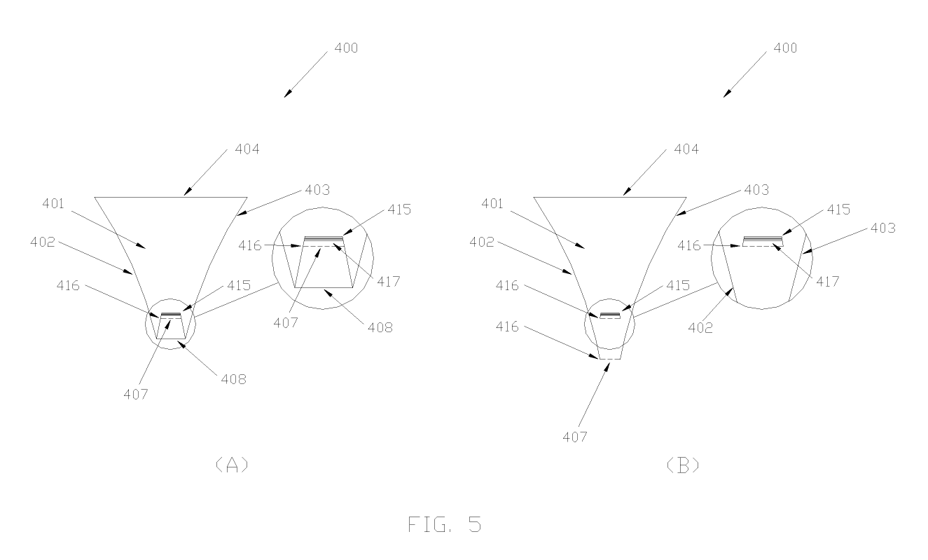

Referring now to FIG. 5, FIGS. 5(a) and 5(b) show another pill crushing pouch according to the present invention. The pouch 400 includes a front face 401, a left edge 402, a right edge 403, a top front edge 404, an internal cavity 406, a dispensing end 407, a fold line 408, a dispensing end seal 415, a dispensing end perforation 416, and a pouch fixed portion 417.

The pouch 400 shown in FIG. 5(a) is ready for use. In use, one or more pills are placed in the pouch 400, such that the pill or pills resides inside of the pouch 400, in the internal cavity 406. The pouch 400 containing the pill or pills can then be inserted fully or partially into a pill crushing device, such as the device described in the '963 patent, or the pills can be crushed through any available means, including crushing with a hammer or other blunt device. After the desired amount of crushing has been achieved, the operator can remove the pouch 400 from the crushing device, and the product is now ready for dispensing. Once the operator is ready to dispense the product into a receiving container, such as a cup of applesauce, the operator simply positions the pouch 400 over the receiving container, and tears the pouch 400 at the dispensing end perforation 416, which frees the dispensing end 407 of the pouch 400.

At this point, the pouch 400 takes the form shown in FIG. 5(b). As shown on the figure, the pouch fixed portion 417 remains fixed to the pouch 400, leaving the dispensing end seal 415 and a portion of the dispensing end perforation 416. The mating portion of the dispensing end perforation 416 resides on the dispensing end 407. The dispensing end 407 now hangs down and allows the crushed product to easily dispense through the dispensing end 407. Note that during manufacturing, the perforating step to create the dispensing end perforation 416 is only a perforation, not a seal, such that after the dispensing end 407 is torn away from the pouch fixed portion 417, the dispensing end 407 is not in any way sealed, but fully open to the internal cavity 406.

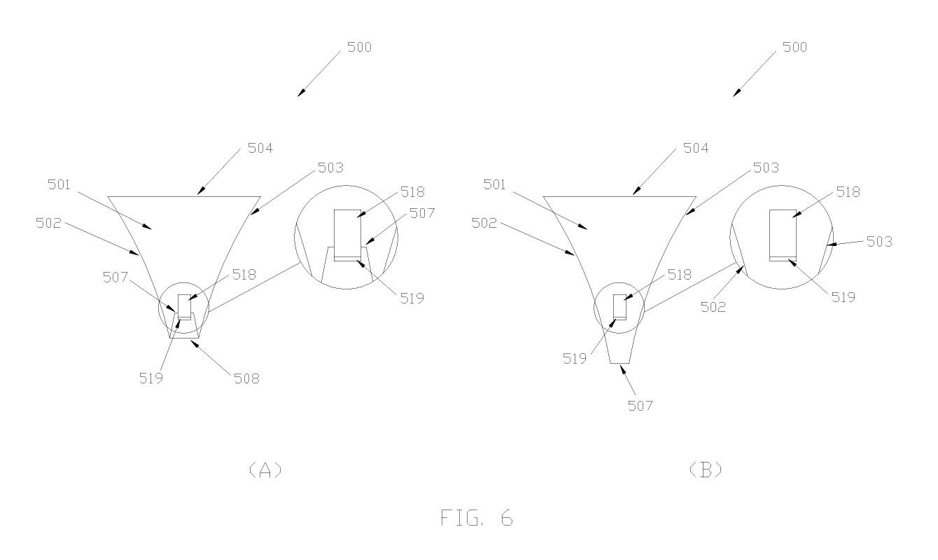

Referring now to FIG. 6, FIGS. 6(a) and 6(b) show another pill crushing pouch according to the present invention. The pouch 500 includes a front face 501, a left edge 502, a right edge 503, a top front edge 504, an internal cavity 506, a dispensing end 507, a fold line 508, a piece of tape 518, and an optional non-sticky section of tape 519.

The pouch 500 shown in FIG. 6(a) is ready for use. In use, one or more pills are placed in the pouch 500, such that the pill or pills resides inside of the pouch 500, in the internal cavity 506. The pouch 500 containing the pill or pills can be crushed as desired as described above. Once the operator is ready to dispense the product into a receiving container, the operator simply positions the pouch 500 over the receiving container, and peals the piece of tape 518 off of the pouch 500, which frees the dispensing end 507 of the pouch 500. If the optional non-sticky section of tape 519 is employed as shown, the operator can simply peal the piece of tape 518 off of the dispensing end 507 which frees the dispensing end 507 of the pouch 500, allowing the user to keep the piece of tape 518 on the pouch 500 for convenience.

At this point, the pouch 500 takes the form shown in FIG. 6(b). As shown on the figure, the piece of tape 518 remains fixed to the pouch 500, as the optional non-sticky section of tape 519 is employed. The dispensing end 507 now hangs down and allows the crushed product to easily dispense through the dispensing end 507. Although any type of tape or other flat sealing means can be used, preferably an “easy peal” type of tape is used, such that the user can easily peal the piece of tape 518 during use.

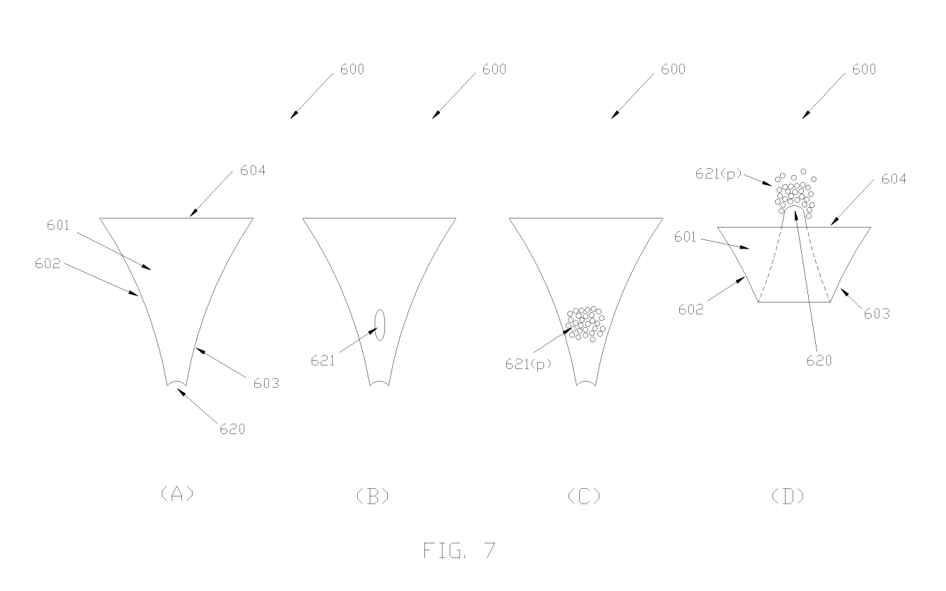

Referring now to FIG. 7, FIG. 7(a) through 7(d) show another pill crushing pouch according to the present invention. The pouch 600 includes a front face 601, a left edge 602, a right edge 603, a top front edge 604, an internal cavity 606, and a bottom end 620.

The pouch 600 shown in FIG. 7(a) is ready for use. In use, a pill 621 is placed in the pouch 600, such that the pill or pills resides inside of the pouch 600, in the internal cavity 606. Note optionally more than one pill may be used. The pouch 600 containing the pill 621 is shown in FIG. 6(b) and can be crushed as desired as described earlier. After crushing, the pill is a powder, represented as 621(p) as shown in FIG. 6(c). Once the operator is ready to dispense the product into a receiving container, the operator simply positions the pouch 600 near the receiving container, and slowly turns the pouch upside-down, such that the user pours out the crushed pill 621(p) from the pouch 600. To ensure that all of the crushed pill 621(p) is dispensed from the pouch 600, the user pushes the bottom end 620 with a finger, pencil, pen or other suitable device to turn the pouch 600 partially inside-out, as shown in FIG. 7(d).

It is important to note the shape of the bottom end 620 of the pouch 600. The shape of the bottom end 620 is convex, such that when it is turned inside-out during dispensing, there are no crevices or other features to retain or trap crushed pill 621(p), thus allowing all of the crushed pill 621(p) to be dispensed. Optionally, while still positioned over the receiving container, the pouch 600 may be tapped gently with a finger or pencil or other convenient device to free any residual pill product that may be adhered to the walls of the pouch 600.

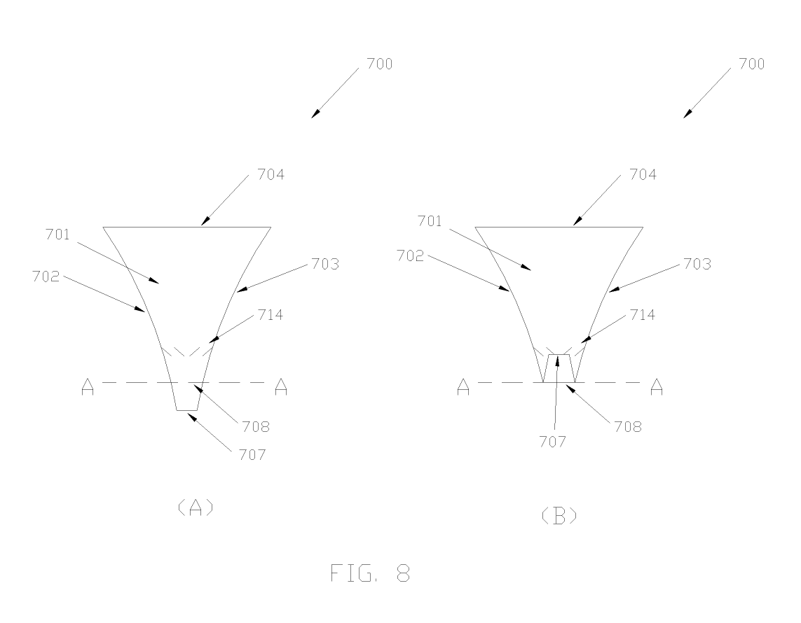

Referring now to FIG. 8, FIGS. 8(a) and 8(b) show another pill crushing pouch according to the present invention. The pouch 700 includes a front face 701, a left edge 702, a right edge 703, a top front edge 704, an internal cavity 706, a dispensing end 707, a fold line 708, and a pill hold perforations 714.

The pouch 700 shown in FIG. 8(a) is ready for use. In use, one or more pills are placed in the pouch 700, such that the pill or pills resides inside of the pouch 700, in the internal cavity 706, resting on the pill hold perforations 714. At this point, the pouch 700 of

FIG. 8(a) has several possible modes of use, including:

In a first possible mode, the pouch 700 may be used in a similar way as to the pouch 100 described above, where the pouch 700 would be folded at the fold line 708 prior to crushing a pill or pills, and unfolded when it is desired to dispense the crushed pills from the dispensing end 707.

In a second possible mode, the pouch 700 may be positioned in a crushing device that is elevated such that a receiving container may be placed beneath it. In this mode, the pouch 700 is placed in the pill crusher, with the dispensing end 707 placed above a receiving container. When the pill or pills are crushed, the smaller crushed particles fall between the perforations of the pill hold perforations 714 and conveniently into the receiving container.

In a third possible mode, the pouch 700 can be held substantially horizontally while the pills are crushed and then turned and held vertically over a receiving container to dispense the crushed product through the dispensing end 407. The pill hold perforations 714 provide a resistance to the very easy flow of crushed product when horizontal, but yet allow the crushed product to dispense when vertical.

The pill hold perforations 714 may be of any size, shape, and orientation. The pill hold perforations 714 shown in FIG. 8 are angled, such that they do not trap crushed pill product. Optionally, the openings created by the pill hold perforations 714 are sized such that only a desirable crushed particle size can fit through, thus creating a filter that passes only desired product size.

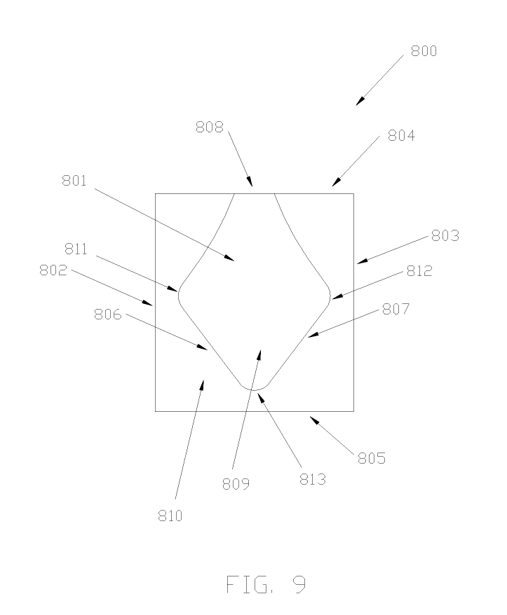

Referring now to FIG. 9, another pill crushing pouch according to the present invention is shown. The pouch 800 includes a front face 801, a left outer edge 802, a right outer edge 803, a top front edge 804, a bottom edge 805, a left internal edge 806, a right internal edge 807, an opening 808, an internal cavity 809, a void cavity 810, a left internal corner 811, a right internal corner 812, and a bottom internal corner 813.

One key design feature of the pouch 800 is that there are no internal surfaces that are prone to capture crushed pill product. Specifically, the left internal corner 811, the right internal corner 812, and the bottom internal corner 813 each have a radius that eliminates a sharp corner, and join angled features that funnel the crushed product to the opening 808.

The pouch 800 shown in FIG. 9 is ready for use. In use, one or more pills are placed in the pouch 800, through the opening 808 such that the pill or pills resides inside of the pouch 800, in the internal cavity 809. The pouch 800 containing the pill or pills can be crushed as desired as described above. Once the operator is ready to dispense the product into a receiving container, the operator simply positions the pouch 800 near the receiving container, and slowly turns the pouch upside-down, such that the user pours out the crushed product from the pouch 800.

The pouches of the present invention can be formed through various industrial processes. For example, they may be formed from a single sheet of flexible material such as high-density or low-density polyethylene, or other suitable material. When using a plastic such as polyethylene, edge seals and other points where the sheet material needs to be fused can be easily accomplished by applying localized heat with a heat sealer or ultrasonic sealer as is well known in the art of polymer engineering. The polyethylene sheet is cut into sheets precisely as possible to the size of the final desired pouch, and then two sheets are laid one on top of the other to form a two-layer set. Alternatively, one sheet can be cut to the proper dimension and folded over onto itself to form a two-layer set, a front and back layer, each layer nearly identical in size, and nearly the size of the final desired pouch.

At this point, a heat seal is applied to the required locations. A heat seal is applied to portions of the material to seal the front and back layers together at specific locations and to form a seal lines as indicated generally in the Figures. For example, referring to FIG. 3(a), a heat seal would be applied to the pouch 200 along the left edge 202, the right edge 203, forming the internal cavity 206, and along the left outer edge 211 and the right outer edge 212, as well as along the bottom edge, except for the location of the dispensing end 207, which needs to be open to the internal cavity. Alternatively, the entire bottom edge may be heat sealed and then cut or otherwise unsealed to provide for the opening at the dispensing end 207. Brand name, manufacturing location, and other features may be stamped or printed on the pouch 200.

If a design such as that shown in FIG. 1 is desired, the sheet material may be trimmed to size prior to apply heat or ultrasonic seals, or the pouch 100 may be manufactured as above (without unnecessary seals such as those along an outer edge) and then trimmed after seals are made.

Preferably, the sheet material is less than 500 micrometers in thickness, and more preferably less than 200 micrometers in thickness.

Alternatively, a pouch of the present invention may be formed by using flat tubing, a continuous cylindrical product offered by many manufactures of polyethylene. Such products are offered in a variety of thicknesses, including 500 micrometers and thinner.

Given that some medications demand that a complete dose be given to the patient, the pouches of the present invention are preferably made from a translucent material and more preferably transparent material, although any material that can withstand the force to crush the desired pill or pills is suitable. Furthermore, if required by a regulating agency, such as the United States Food and Drug Administration (FDA), the material of manufacture may be required to be “FDA Compliant,” such that the FDA has determined a material is suitable to be used in contact with products that will be consumed by humans.

The following materials may be made to be FDA compliant and may be suitable for manufacturing the pouch: high density polyethylene (HDPE), low density polyethylene (LDPE), ultra-high molecular weight polyethylene (UHMW or UHMWPE), very-high molecular weight polyethylene (VHMW or VHMWPE), Fluoropolymers such as DuPont Teflon® products, polyetherimide, and polymethylpentene. Other materials may be used and the foregoing list should not be considered to limit the materials of manufacture for the invention herein. For example, paper products or other cellulose based materials may be used.

Although the invention has been described with respect to specific preferred embodiments for a complete and clear disclosure, the appended claims are not to be thus limited but are to be construed as embodying all modifications and alternative constructions that may occur to one skilled in the art and which fairly fall within the basic teaching therein set forth.

What is claimed is:

1. A pill crusher pouch, comprising: a flexible sheet material folded flat upon itself to provide a close interior with sufficiently tight wall to wall contact to help facilitate pill crushing there between; said interior with wall to wall contact being sealed along a longitudinal edge portion thereof to form a pouch having a front panel and a back panel; said pouch open on the top and bottom portions which allow the easy releasing of any accumulation of pulverized pill material thereat to facilitate the dispensing of pulverized pill material from the dose interior of said open pouch.

2. The pill crusher pouch according to claim 1, wherein said flexible sheet material is a sheet of transparent material.

3. The pill crusher pouch according to claim 1, wherein said sheet of flexible material is composed of polyethylene.
